(19) United States
(12) Patent Application Publication
(10) Pub. No.: US 2015/0022460 A1
(43) Pub. Date: Jan. 22, 2015

(54) INPUT CHARACTER CAPTURE ON TOUCH SURFACE USING CHOLESTERIC DISPLAY

(71) Applicant: Lenovo (Singapore) Pte. Ltd., Singapore (SG)

(72) Inventor: Scott Edwards Kelso, Cary, NC (US)

(21) Appl. No.: 13/943,974

(22) Filed: Jul. 17, 2013

(51) Int. Cl. G06F 3/0488

(52) U.S. Cl. CPC G06F 3/04883
USPC 345/173

(57) ABSTRACT

An aspect provides a method, including: accepting, at a touch surface of an information handling device, one or more touch inputs; providing, at the touch surface of the information handling device, one or more visual renderings corresponding to the one or more touch inputs; identifying, using at least one processor, a character included in the one or more touch inputs; and rendering, on a separate display device of the information handling device, the character identified. Other aspects are described and claimed.

### BACKGROUND

Information handling devices (“devices”), for example cell phones, smart phones, tablet devices, laptop and desktop computers, navigation systems, e-readers, etc., employ one or more input devices. Among these input devices are input surfaces such as a touch sensitive input surface, for example touch pads and digitizers.

Input surfaces such as digitizers and touch pads continually record the location of a stylus pointer or finger (relative to the input surface). This location information may be reported to the system, e.g., typically the operating system (OS) uses this location information to render some visual effect on a display screen based on the location information. Handwriting is an increasingly common form of input to such input surfaces. Users often provide handwriting input with the assistance of a pen or stylus, although this is not required and a user may in fact provide handwriting input simply using his or her finger.

For many inputs, e.g., characters used in ideogram-based languages such as Chinese or Japanese, traditional keyboard input is cumbersome. For example, many characters are built up from a series of pen strokes and are difficult to describe with an alphabet-style keyboard. Instead, characters must be entered using indirect means, e.g., an input method editor such as MICROSOFT PINYIN input method editor software. In such an input method editor, a user types phonetically or enters strokes using a dictionary; however, many users find such input mechanisms unnatural. Using such input mechanisms amounts to requiring a user to learn another language, i.e., the language and style of the particular input method editor product.

Thus, handwriting is a desirable mode of input for many users, including those wishing to enter characters of a character-based language, Latin-based characters (e.g., letters of an alphabet), and characters is the form of symbols, etc. Although handwriting is a natural mode of input that many users enjoy, using current devices there are certain drawbacks to the use of handwriting input.

### BRIEF SUMMARY

In summary, one aspect provides a method, comprising: accepting, at a touch surface of an information handling device, one or more touch inputs; providing, at the touch surface of the information handling device, one or more visual renderings corresponding to the one or more touch inputs; identifying, using at least one processor, a character included in the one or more touch inputs; and rendering, on a separate display device of the information handling device, the character identified.

Another aspect provides an information handling device, comprising: a touch surface; a display device; one or more processors; a memory device accessible to the one or more processors and storing code executable by the one or more processors to: accept, at the touch surface, one or more touch inputs; providing, at the touch surface, one or more visual renderings corresponding to the one or more touch inputs; identifying, using at least one processor, a character included in the one or more touch inputs; and rendering, on the display device, the character identified.

A further aspect provides a program product, comprising: a storage device having computer readable program code stored therewith, the computer readable program code comprising: computer readable program code configured to accept, at a touch surface of an information handling device, one or more touch inputs; computer readable program code configured to provide, at the touch surface of the information handling device, one or more visual renderings corresponding to the one or more touch inputs; computer readable program code configured to identify, using at least one processor, a character included in the one or more touch inputs; and computer readable program code configured to render, on a separate display device of the information handling device, the character identified.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates an example method of input character capture on touch surface using cholesteric display.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

In providing inputs to an information handling device many users desire to utilize handwriting as a mode of input, i.e., enter characters (alphabet letters, characters of a character-based language, symbols, etc.). Methods of handwriting on a touch screen exist. However, not all devices have a touch screen capable of accepting handwriting input (e.g., a laptop computer with a touch pad or digitizer and no touch screen). Moreover, in conventional arrangements, a user of such input devices (touch pad, digitizer) cannot see a visual representation of what has been written co-located with the input device. In other words, a user providing handwriting to a touch pad or digitizer will see the resultant input rendered on a separate display screen (e.g., an LCD panel of a clamshell style laptop device). It is therefore difficult for a user in such a circumstance to provide accurate handwriting inputs.

Accordingly, an embodiment provides a visual layer to a touch pad or digitizer (i.e., non-touch screen handwriting input device). This provides the user with real time visual feedback with respect to handwritten inputs that is co-located with the handwritten inputs. A result is visual feedback that assists the user in making accurate handwriting inputs to the input surface and relieves the user of looking elsewhere (e.g., on a separate LCD panel) for a visual rendering of the inputs.

The illustrated example embodiments will be best understood by reference to the figures. The following description is intended only by way of example, and simply illustrates certain example embodiments.

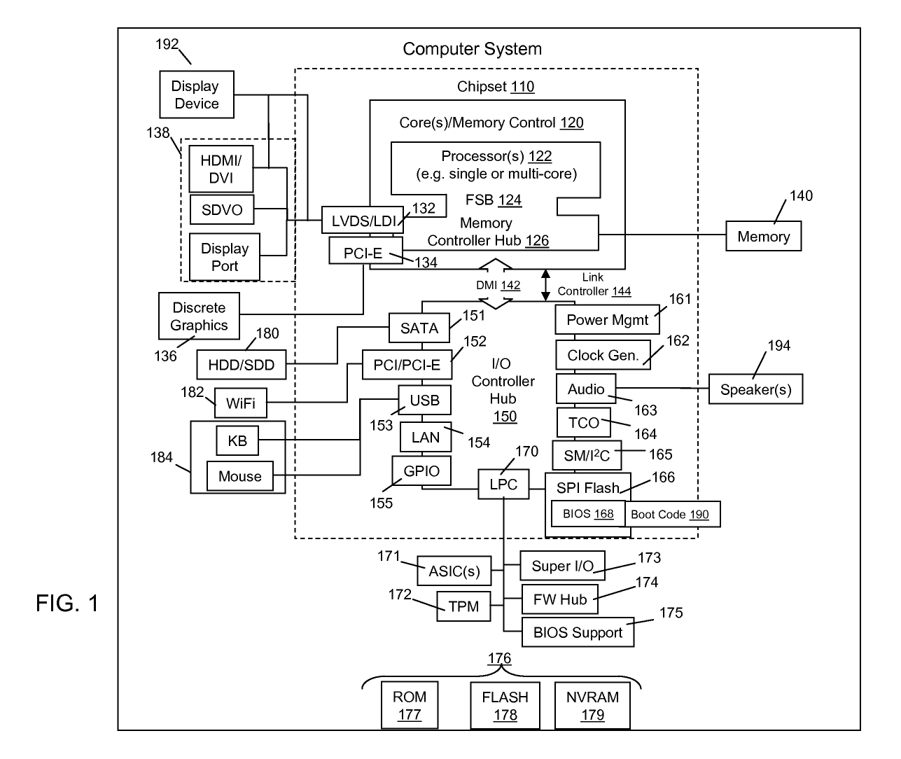

While various other circuits, circuitry or components may be utilized, FIG. 1 depicts a block diagram of one example of information handling device circuits, circuitry or components. The example depicted in FIG. 1 may correspond to computing systems such as the THINKPAD series of personal computers sold by Lenovo (US) Inc. of Morrisville, N.C., or other devices. As is apparent from the description herein, embodiments may include other features or only some of the features of the example illustrated in FIG. 1.

The example of FIG. 1 includes a so-called chipset 110 (a group of integrated circuits, or chips, that work together, chipsets) with an architecture that may vary depending on manufacturer (for example, INTEL, AMD, ARM, etc.). The architecture of the chipset 110 includes a core and memory control group 120 and an I/O controller hub 150 that exchanges information (for example, data, signals, commands, et cetera) via a direct management interface (DMI) 142 or a link controller 144. In FIG. 1, the DMI 142 is a chip-to-chip interface (sometimes referred to as being a link between a “northbridge” and a “southbridge”). The core and memory control group 120 include one or more processors 122 (for example, single or multi-core) and a memory controller hub 126 that exchange information via a front side bus (FSB) 124; noting that components of the group 120 may be integrated in a chip that supplants the conventional “northbridge” style architecture.

In FIG. 1, the memory controller hub 126 interfaces with memory 140 (for example, to provide support for a type of RAM that may be referred to as “system memory” or “memory”). The memory controller hub 126 further includes a LVDS interface 132 for a display device 192 (for example, an LCD panel, a CRT, a flat panel, touch screen, et cetera). A block 138 includes some technologies that may be supported via the LVDS interface 132 (for example, serial digital video, HDMI/DVI, display port). The memory controller hub 126 also includes a PCI-express interface (PCI-E) 134 that may support discrete graphics 136.

In FIG. 1, the I/O hub controller 150 includes a SATA interface 151 (for example, for HDDs, SDDs, 180 et cetera), a PCI-E interface 152 (for example, for wireless connections 182), a USB interface 153 (for example, for devices 184 such as a digitizer, keyboard, mice, cameras, phones, storage, other connected devices, et cetera), a network interface 154 (for example, LAN), a GPIO interface 155, a LPC interface 170 (for ASICs 171, a TPM 172, a super I/O 173, a firmware hub 174, BIOS support 175 as well as various types of memory 176 such as ROM 177, Flash 178, and NVRAM 179), a power management interface 161, a clock generator interface 162, an audio interface 163 (for example, for speakers 194), a TCO interface 164, a system management bus interface 165, and SPI Flash 166, which can include BIOS 168 and boot code 190. The I/O hub controller 150 may include gigabit Ethernet support.

The system, upon power on, may be configured to execute boot code 190 for the BIOS 168, as stored within the SPI Flash 166, and thereafter processes data under the control of one or more operating systems and application software (for example, stored in system memory 140). An operating system may be stored in any of a variety of locations and accessed, for example, according to instructions of the BIOS 168. As described herein, a device may include fewer or more features than shown in the system of FIG. 1.

Information handling devices, as for example outlined in FIG. 1, may provide input surfaces (e.g., digitizer or touch pad) that allow a user to provide handwriting input (e.g., via touch input using a finger tip or stylus, etc.) separate from the display screen. In an embodiment, a visual feedback layer is provided to such an input surface (e.g., touch pad or digitizer) such that the user may find a visual rendering of the inputs provided thereto.

In one embodiment, the visual layer may be formed of a cholesteric LCD layer. In such a layer, pressure of the input, e.g., as provided from a stylus or pen tip, is utilized by the visual layer to physically alter the material (e.g., cholesteric material) of the layer. This alteration is in turn registered as a visual rendering of the inputs on the touch surface. In one embodiment, the visual layer may itself provide for digital input to the system, i.e., for rendering on a separate display screen, e.g., LCD panel of a clamshell style laptop device.

In another embodiment, two or more layers may be provided. For example, in an embodiment a separate input layer may be provided such that one layer provides visual feedback and another layer provides location input (x, y, coordinates) to the system. In one example, an embodiment may provide a cholesteric layer for visual feedback and a separate overlay layer formed from a flexible touch sensitive material. In another example, an embodiment may provide a cholesteric layer for visual feedback and an underlying touch input layer (e.g., electromagnetic resonance (EMR) pen digitizer) underneath the cholesteric layer for providing inputs to the system. Therefore, using one of a variety of arrangements and embodiment provides a touch pad or digitizer that both registers location inputs (and provides these to the system) as well as provides a visual feedback corresponding to the inputs.

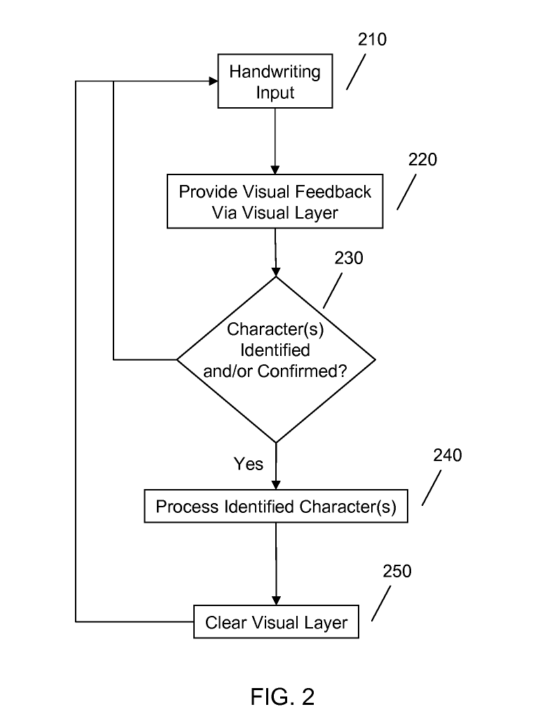

Referring to FIG. 2, a user may provide handwriting inputs (e.g., character strokes, alphabet characters, symbols, etc.) to the input surface (e.g., touch pad) using a pointed or tipped capacitive stylus at 210. Each handwriting input may be built up (e.g., provisioning of character strokes in the example of a character of a character-based language) that it is recognized by the system at 230. Otherwise, the system may await further inputs. This may optionally include the user confirming that the input is correctly recognized at 230 (e.g., user provides confirming input or selects a character from a candidates list).

During this process, by virtue of inclusion of the visual layer, the user is provided with a visual representation of the handwriting provided to the system that is co-located with the input device at 220. In the example of a touch pad or digitizer, the visual layer may be included with the touch pad or digitizer such that visual renderings of the handwriting input are provided in real time (or near real time) on the touch pad or digitizer to the user at 220 as the user interfaces with the touch pad or digitizer. This will assist the user greatly in understanding the nature and quality of the handwriting input provided to the touch pad or digitizer (and in turn to the system). If the user is not done entering inputs or the system does not yet recognize a character, the system may await further inputs.

Thereafter, i.e., once the system (and optionally as confirmed by the user) has interpreted the handwriting input to the point that it may be identified and matched to a character, an embodiment may process the identified input at 240, e.g., enter the character into an on-screen display. For example, an embodiment may input an identified character into an application rendered on a separate LCD panel. Thereafter, an embodiment may erase the visual layer at 250 (e.g., erase the cholesteric layer) such that the input device (e.g., touch pad or digitizer) is prepared to receive further inputs from the user.

An input that is properly recognized and/or confirmed may be used by the system to perform some action at 240. For example, a recognized handwritten character may be input as a machine character (in place of the recognized handwritten character) into an application such as word processing application or a web browsing application as displayed on the separate display device (e.g., LCD panel of a laptop). Thus, the visual feedback rendering will be cleared at 250 and the timing of clearing may be coordinated with the inputting and identifying of discrete characters. The timing and implementation of erasing the visual layer may be modified. For example, the system may default to erasing the visual layer following successful character recognition, following the user confirming successful character recognition, or the like.

In an embodiment, the visual layer may be turned off, e.g., by the user selecting a mode of operation where visual feedback is not desirable. In the case of a cholesteric layer, this layer may be turned off by having the system set the layer to automatically erase at very short time intervals.

Moreover, in a use case where the input surface is to be used for non-handwriting input, e.g., for navigation, the visual layer may be either turned off (e.g., via implementation of auto-erasing in the case of a cholesteric layer) or tuned such that light (in terms of pressure of input) navigational inputs are not registered and rendered by the visual layer. In the example of a cholesteric layer, the layer may be designed such that a user needs to apply a predetermined degree of pressure (e.g., as achieved via inputs using the tip of a stylus) prior to a visual response being registered (by virtue of a physical alteration of the cholesteric layer). This ensures that the user rendering navigational input, e.g., using a finger tip or light stylus inputs, will not receive unwanted visual feedback.

Accordingly, an embodiment provides convenient visual feedback for handwriting input with a touch input surface. The visual feedback may be included by provisioning of a cholesteric layer within a non-display touch input surface such as a touch pad or digitizer. In this way, an embodiment supplements the user's ability to utilize such touch input surfaces and lends assistance in providing accurate handwriting input via this mechanism. In may cases, e.g., character-based languages, such a mode of provisioning handwriting input will greatly augment a user's ability to accurately convey to the system the desired input and avoid the need to utilize other input methods (e.g., input method editors) or purchase additional devices (e.g., those having integrated touch screen displays).

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

Any combination of one or more non-signal device readable medium(s) may be utilized. The non-signal medium may be a storage medium. A storage medium may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider) or through a hard wire connection, such as over a USB connection.

Aspects are described herein with reference to the figures, which illustrate example methods, devices and program products according to various example embodiments. It will be understood that the actions and functionality may be implemented at least in part by program instructions. These program instructions may be provided to a processor of a general purpose information handling device, a special purpose information handling device, or other programmable data processing device or information handling device to produce a machine, such that the instructions, which execute via a processor of the device implement the functions/acts specified.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, comprising:
accepting, at a touch surface of an information handling device, one or more touch inputs;
providing, at the touch surface of the information handling device, one or more visual renderings corresponding to the one or more touch inputs;
identifying, using at least one processor, a character included in the one or more touch inputs; and
rendering, on a separate display device of the information handling device, the character identified.

2. The method of claim 1, wherein the touch surface comprises a visual layer.

3. The method of claim 2, wherein the visual layer comprises a cholesteric layer.

4. The method of claim 3, wherein the touch surface comprises a touch input layer.

5. The method of claim 4, wherein the touch input layer comprises a flexible input layer overlaying the cholesteric layer.

6. The method of claim 4, wherein the touch input layer comprises a stylus sensing layer underlying the cholesteric layer.

7. The method of claim 3, further comprising erasing the cholesteric layer following the identifying of the character included in the one or more touch inputs.

8. The method of claim 1, wherein the touch surface is selected from the group of touch surfaces consisting of a touch pad and a digitizer.

9. The method of claim 1, wherein the separate display device comprises an LCD panel.

10. The method of claim 1, wherein the information handling device comprises a clamshell style laptop computer.

11. An information handling device, comprising:
a touch surface;
a display device;
one or more processors;
a memory device accessible to the one or more processors and storing code executable by the one or more processors to:
accept, at the touch surface, one or more touch inputs;
providing, at the touch surface, one or more visual renderings corresponding to the one or more touch inputs;
identifying, using at least one processor, a character included in the one or more touch inputs; and
rendering, on the display device, the character identified.

12. The information handling device of claim 11, wherein the touch surface comprises a visual layer.

13. The information handling device of claim 12, wherein the visual layer comprises a cholesteric layer.

14. The information handling device of claim 13, wherein the touch surface comprises a touch input layer.

15. The information handling device of claim 14, wherein the touch input layer comprises a flexible input layer overlaying the cholesteric layer.

16. The information handling device of claim 14, wherein the touch input layer comprises a stylus sensing layer underlying the cholesteric layer.

17. The information handling device of claim 13, wherein the code is further executable by the one or more processors to erase the cholesteric layer following identification of the character included in the one or more touch inputs.

18. The information handling device of claim 11, wherein the touch surface is selected from the group of touch surfaces consisting of a touch pad and a digitizer.

19. The information handling device of claim 11, wherein the display device comprises an LCD panel.

20. A program product, comprising:
a storage device having computer readable program code stored therewith, the computer readable program code comprising:
computer readable program code configured to accept, at a touch surface of an information handling device, one or more touch inputs;
computer readable program code configured to provide, at the touch surface of the information handling device, one or more visual renderings corresponding to the one or more touch inputs;
computer readable program code configured to identify, using at least one processor, a character included in the one or more touch inputs; and
computer readable program code configured to render, on a separate display device of the information handling device, the character identified.
